(19) United States
(12) Patent Application Publication
(10) Pub. No.: US 2011/0025072 A1
(43) Pub. Date: Feb. 3, 2011

(54) SYSTEM AND METHOD FOR WATER DESALINATION AND OTHER USES

(76) Inventor: Shmuel Ovadia, Tel Aviv (IL)

Correspondence Address: HYRA IP, PLC, 11710 Plaza America Drive, Suite 2000, Reston, VA, 20190, US

(21) Appl. No.: 12/668,702

(22) PCT Filed: Mar. 10, 2009
(86) PCT No.: PCT/IL09/00270

§ 371 Date: Jan. 12, 2010

(30) Foreign Application Priority Data
Mar. 19, 2008 (IL) 190300

(51) Int. Cl. H02K 7/18; F03B 13/18

(52) U.S. Cl. 290/1 R; 60/498

(57) ABSTRACT

A system for converting wave energy into rotary motion and for sea water desalination, including buoyancy means upon sea waves wherein the buoyancy means move according to the sea waves motion; a piston, containing fluid, wherein the piston is pivotally attached to the buoyancy means, thereby converting mechanical kinetic energy into hydraulic pressure of fluid. A hydraulic system that includes pipes and one or more one-directional valves for allowing pressure conservation in the hydraulic system even after releasing the piston. The fluid pressure is preferably stored in a pressure container. The system further includes a hydraulic motor that is operatively connected to the hydraulic system wherein the hydraulic pressure creates a flow of fluid that operatively rotates the hydraulic motor. The rotary motion can then be used for sea water desalination and for other uses.

### CROSS REFERENCE TO RELATED APPLICATIONS

This application claims the benefit from Israeli (IL) patent application 190,300 filed Mar. 19, 2008, the disclosure of which is included herein by reference.

### FIELD OF THE INVENTION

The present invention relates to energy utilization systems. More particularly, the present invention relates to a system having buoyancy means, one or more pistons connected to a closed loop hydraulic system and motors designed to convert linear kinetic energy of undercurrents in the entry and exit, and rise and fall of sea waves, into rotary kinetic energy. The energy produced by the system is up to four times higher than that of many prior art alternatives. The system can use the rotary energy for sea water desalination and for other uses.

### BACKGROUND OF THE INVENTION AND PRIOR ART

The complex and changing character of sea waves—their refraction patterns on the beach, as well as other factors—was not always taken into account for the purpose of realizing an efficient system that will exploit the sea's energy (and wave power in particularly).

Some systems installed in the sea's vicinity are unfriendly to the environment, and may create pollution as a result of the burning of fuels. This becomes extremely relevant in regard to remote desalination systems that need energy to operate and sea water to desalinate. The dependency on non-renewable energy resources might be problematic in a desalination environment.

There are many shorelines in the world that have a shortage of water and there is a need for a desalination system that will not create any pollution; that will be erected at a reasonable price; and that does not need fuels to operate.

We know today of many different methods to operate pumps for desalination of sea water. However, most of the prior art methods have a low energy efficiency and very high maintenance costs. For example, systems that are submerged under water and thereby exposed to severe weather conditions in a stormy sea.

Some prior art systems do not have proper control and thereby barely make use of one directional motion of waves flux. Shortage in drinking water is evidence of the fact that there is no cost attractive system for the desalination of sea water. Furthermore, for systems that are substantially submerged under water, there is a substantial risk of accelerated erosion and faults due to storms and changing weather conditions.

### SUMMARY OF THE INVENTION

The present invention describes a system for producing potable fresh water and exploits the waves in four different situations: at the wave's entry; at its exit; at its rise; and at its fall and thereby, the system is designed to capture energy from sea waves.

The system is environment-friendly: it is non-polluting, does not burn any fuels and exploits a renewable energy source (sea waves). The present invention is intended to solve the water shortage problem along coastal areas, without pollution and at a substantially low price—no fuel cost!

A new method enables the operation of higher-efficiency desalination pumps at a practical cost. The system and/or equipment parts implemented in this fashion may be outside of the sea and thus be protected against severe weather conditions.

The system is able to extract energy from wave motion in multiple ways. An attractive and feasible solution is reached for the supply of drinking water. The system includes buoys that may be attached to a stationary object, such as poles affixed to the sea floor or to a tide breaker. Between the buoys and the stationary object, hydraulic pistons are installed, such that the pistons compress hydraulic oil as a reaction to any wave motion.

Regulation of motion from any direction causes the piston to move in and out a coupled cylinder, respectively, and thereby cause the fluid inside the piping system, connected to the cylinder, to compress towards an accumulator/pressure-container, which may contain a hydro-pneumatic device partly filled with gas and partly filled with fluid, having a diaphragm separating them. The pistons receive the consumed fluid from a special reserve fluid (i.e. oil) tank, thus making a circular fluid flow. When the fluid is pressurized in the pressure chambers, the compressed fluid is transferred through regulators and valves to a hydraulic motor which produces rotary motion. The hydraulic energy may be used for water desalination.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 illustrates a desalination system, according to embodiments of the present invention;

FIG. 2 illustrates a system that converts sea wave energy to mechanical energy, according to variations of the present invention;

FIGS. 3a and 3b illustrate a side view and a top view, respectively, of the mechanical float system for efficiency of sea wave energy, according to other variations of the present invention; and

FIG. 4 provides details of a piston in a desalination system, according to embodiments of the present invention.

### DESCRIPTION OF THE PREFERRED EMBODIMENTS

Before explaining embodiments of the invention in detail, it is to be understood that the invention is not limited in its application to the details of construction and the arrangement of the components set forth in the host description or illustrated in the drawings.

Unless otherwise defined, all technical and scientific terms used herein have the same meaning as commonly understood by one of ordinary skill in the art of the invention belongs. The methods and examples provided herein are illustrative only and not intended to be limiting.

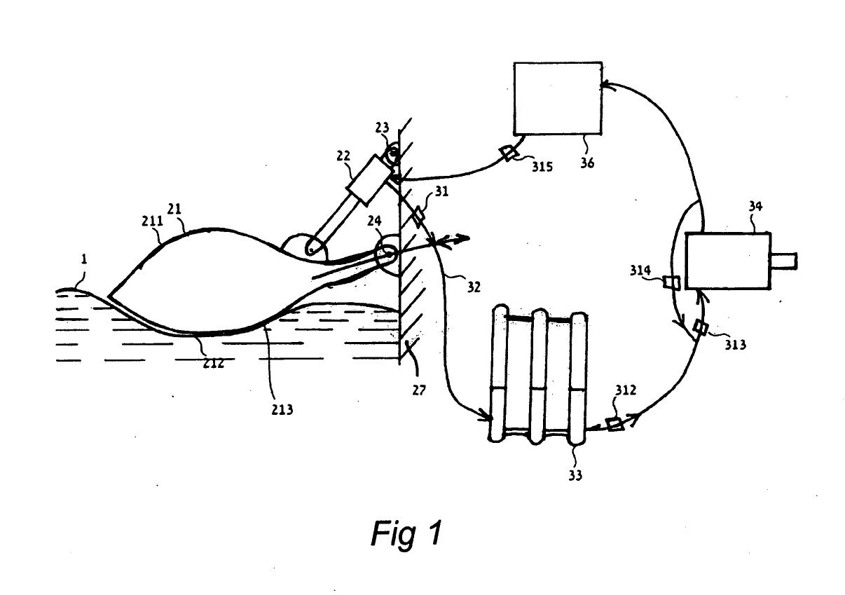

Reference is now made to the Figures. FIG. 1 illustrates a multi-stage system for energy conversion and desalination, according to embodiments of the present invention. The system uses the motion of sea wave 1, for example by using one or more buoys 21. Buoy 21 includes top plane 211 of buoy 21 and bottom plane 212 that form an efficient structure.

Piston 22 creates hydraulic fluid pressure when buoy 21 moves. Piston 22 and buoy 21 are connected by axes 23 and 24, respectively, wherein axes 23 and 24 are affixed to a fixated structure 27. A one-directional switch valve 31 is connected to piston 22 on one side and to the exit pipe of hydraulic fluid 32 on the other side. This enables pressurized fluid flow from piston 22 to pressure containers 33. Multiple pressure containers 33 enable energy storage in the form of pressurized hydraulic fluid and/or gas (i.e., air or nitrogen) that enables compression. In this fashion, pressure is maintained in the containers 33: sea wave energy is routed to move buoy 21 and thereby piston 22, and store the captured energy in container system 33 and maintain the energy in the container system 33 with one-directional valve 31.

The opening of faucet 312 enables pressure to pass through one-directional valve 313 in the outgoing pipe. One-directional valve 313 also includes a regulator valve. Hydraulic engine 34 enables the conversion of the oil pressure into rotational motion, which can then be converted to another energy form, for example electric energy. The electric energy can then be used to operate a water desalination unit. One-directional valve 314 enables passage of pressure back in the opposite pipe. Excess pressure or fluid may be stored in excess pressure container 36. It is possible to route flow to/from container 36 via one-directional valve 315, towards piston 22.

This dynamic structure allows: usage of the motion of buoy 21; routing pressures in the axis system to a circular flow; utilization of wave motion and store the extracted wave energy. Buoys 21s are connected as needed to stationary object 27 such as poles or pieces of concrete such as a rigid tide-breaker. Hydraulic pistons 22, compressing hydraulic oil in any wave 1 motion, are connected between buoy 21 and stationary object 27.

In variations of the present invention, when piston 22 expands or retracts, the fluid inside piston 22 rushes into a system of pipes leading to a hydro-pneumatic storage compartment. The compartment is filled part gas part fluid, with a diaphragm separating them.

Pistons 22 receive the consumed liquid from reserve oil container 36, thus creating a circular oil flow. When the oil is pressurized in pressure container 33, the oil is transferred, via regulators and valves, to hydraulic motor 34. Hydraulic motor 34 produces rotational motion, which creates a combination for the conversion of hydraulic energy to rotational cycles.

It should be noted that the system of the present invention can be built on tide-breakers, rafts or logs. The logs connect to other elements, and together they act as a “road” in the sea. In addition, buoys, oscillating vertically according to the wave motion, are attached.

The system of the present invention may be used to operate a desalination system as well as for other purposes. It is possible to convert the sea-wave energy to cyclical mechanical kinetic energy. The latter may be used for a desalination system that does not consume electrical energy from external source and/or or fuel energy.

Sea wave motion can create oil pressure in pistons 22 and in turn, the hydraulic oil pressure operates hydraulic motor 34. Valves put in between, as well as an oil pressure regulator, will allow oil flow in the direction needed to achieve the desired effect. It is possible to connect a pressure releaser between them and the valves. A tracker can be installed before hydraulic motor 34, in order to lower the columns automatically.

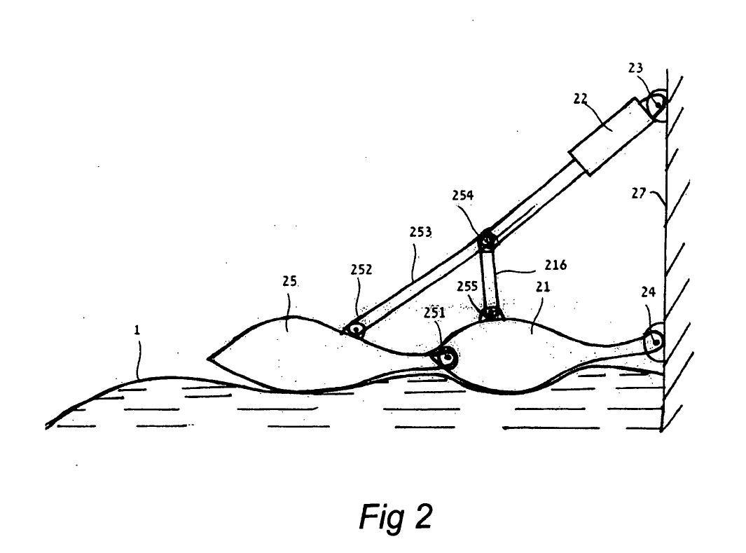

FIG. 2 illustrates a system for conversion of sea waves 1 to mechanical kinetic energy according to variations of the present invention. In this implementation, a second buoy 25 is connected to the first buoy 21 via rotating axis 251 and to a first arm 253 via rotating axis 252. First arm 253 is connected to piston 22 and to a second arm 216 via rotating axis 254, and second arm 216 is further connected to rotating axis 255 that is affixed to first buoy 21.

Rows of buoys can be formed in this manner, either in parallel or in varying directions, wherein each row operatively connected to a single hydraulic system and/or several rows are connected to one hydraulic system.

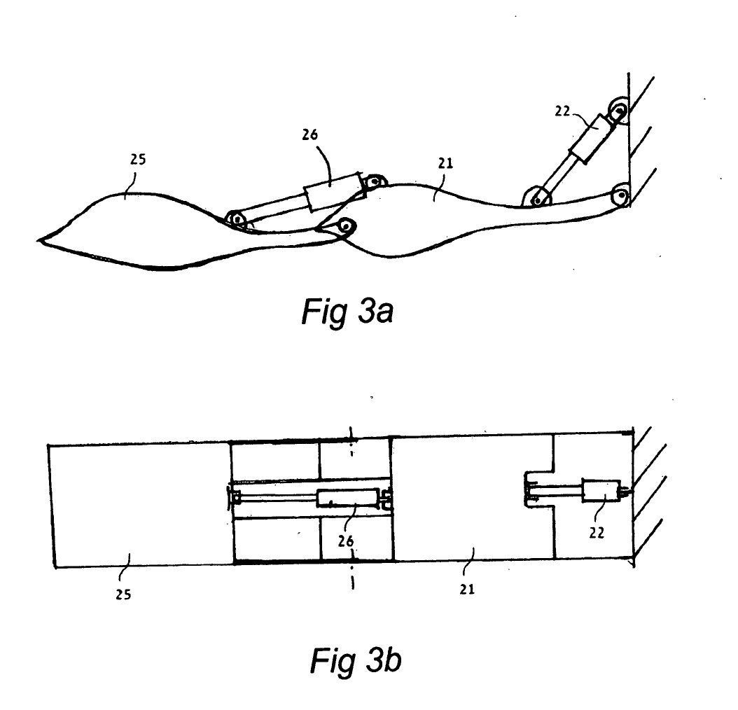

An additional system changes the composition of buoy 21. In one scenario, buoy 21 is filled with air, in order to maximize efficiency of sea wave energy. In another scenario buoy 21 is filled with water, in order to protect the system in case of high tides or storm. Intermediate situations between the above two extremes are possible, wherein buoy 21 is partially filled with water. Thereby the composition of the internal compartment buoys 21 is mechanically coupled to the magnitude of sea waves 1. It is possible to build a system with multiple buoys 21 (a multiple-buoy system) as detailed in FIGS. 2 and 3.

FIGS. 3a and 3b illustrate a side view and a top view, respectively, of the implementation of a buoy system for sea water energy collection, with an additional piston 26 connecting a first buoy 21 to a second buoy 25. The pistons may be of a different shape (cut area), to improve conversion efficiency. Each piston may contain two one-directional valves to create oil flow in one direction, as desired.

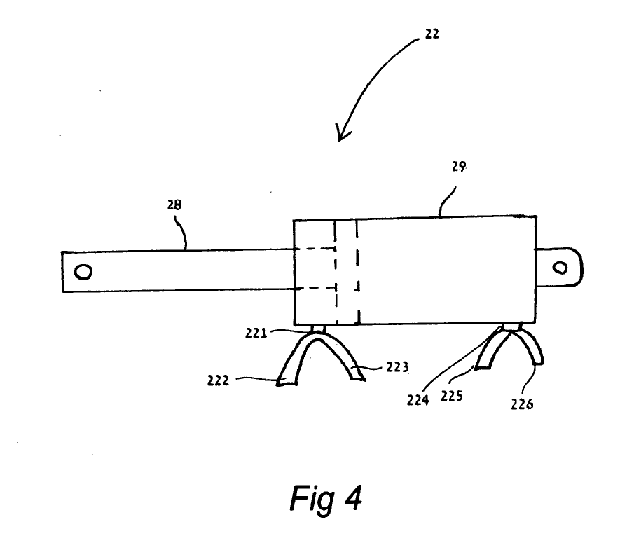

FIG. 4 illustrates details of an example construction of piston 22 in the desalination system, according to embodiments of the present invention. Piston 22 includes camshaft 28 and cylinder 29. Piston 22 further includes valves 221 and 224 in the front and back parts of cylinder 29, respectively, of piston 22. The front and back valves (221 and 224) are attached to entry pipes 223 and 226, and exit pipes 222 and 225, respectively. Both parts of piston 22 are used, in this manner, to create cyclical flow and to control pressures created by the varied directions of sea wave motions.

A pressure container may be installed on the outside to store highly pressurized oil and to filter rippling pressure. The container would optimally include oil and gas, such as air, to allow for its compression.

It should be noted that preferably, the buoys of the present invention are aerodynamically shaped and thereby minimizing the resistance of the buoys to the wave motion.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the claims.

What is claimed is:

1. A system for converting wave energy into rotary motion and for sea water desalination, comprising:
a) buoyancy means upon sea waves wherein said buoyancy means move according to said sea waves motion;
b) a piston, containing liquid, wherein said piston is pivotally attached to said buoyancy means, thereby converting mechanical kinetic energy into hydraulic pressure of fluid;
c) a hydraulic system, comprising:
i. a pipe;
ii. one or more one-directional valves for allowing pressure conservation in the hydraulic system even after releasing said piston; and
d) a hydraulic motor operatively connected to said hydraulic system,
wherein said pipe operatively connects said piston to said hydraulic motor, thereby transferring said hydraulic pressure from said piston to said hydraulic motor; and
wherein said hydraulic pressure creates a flow of liquid that operatively rotates said hydraulic motor.

2. The energy conversion system of claim 1, wherein said hydraulic system further comprising:
iii. a pressure container with gas and fluid, wherein said gas and said fluid are isolated in separate partitions by a flexible isolator,
wherein a first pipe operatively connects said piston to said pressure container, thereby transferring said hydraulic pressure from said piston to said pressure container;
wherein a second pipe operatively connects said pressure container to said hydraulic motor, thereby transferring said hydraulic pressure from said pressure container to said hydraulic motor and wherein said hydraulic pressure creates a flow of liquid that operatively rotates said hydraulic motor; and
wherein said flexible isolator can move freely inside said pressure container and thereby, by closing a coupled one-directional, hydraulic pressure can be accumulated in said fluid partition by compressing said gas.

3. The energy conversion system of claim 2, wherein said flexible isolator, is a diaphragm.

4. The energy conversion system of claim 1 or 2, wherein the hydraulic system further comprising:
iv. pipes and valves, thereby forming a cyclic hydraulic system;

5. The energy conversion system of claim 1 or 2, wherein a reserve container is operatively attached to said hydraulic system on one side and to said piston on the other side, thereby allowing bi-directional transfer of hydraulic fluid according to a valve state.

6. The energy conversion system of claim 1 or 2, wherein said hydraulic motor, is operatively connected to a desalination system.

7. The energy conversion system of claim 1 or 2, wherein said buoyancy means comprises one or more buoys, wherein each of said buoys comprises one or more inner compartments.

8. The energy conversion system of claim 7, wherein said inner compartments are filled with liquid/gas;

9. The energy conversion system of claim 8, wherein one or more of said buoys further comprises a pump for filling said one or more inner compartments of said buoys with liquid/gas.

10. The energy conversion system of claim 9, wherein said pump is used for removing liquid/gas from said one or more inner compartments of said buoys.

11. The energy conversion system of claim 1 or 2, wherein each of said buoys is coupled with one of said pistons, having two ends, wherein a first end of said piston is pivotally attached to said coupled buoy, and a second end of said piston is pivotally attached to a stationary object.

12. The energy conversion system of claim 2, wherein said buoyancy means comprises one or more rows of said buoys attached to one another, each row having a first end buoy and a second end buoy,
wherein in each of said rows, each of said buoys is interconnected to the adjacent buoys by one of said pistons;
wherein at least said first end buoy of each of said rows is operatively connected to said pressure container; and
wherein said second end buoy of each of said rows is pivotally attached by one of said pistons to a stationary object.

13. The energy conversion system of claim 2, wherein said buoyancy means comprises one or more rows of said buoys attached to one another, each row having a first end buoy and a second end buoy,
wherein in each of said rows, each of said buoys is pivotally interconnected to the adjacent buoys;
wherein said second end buoy of each of said rows is pivotally attached to a stationary object;
wherein a piston is attached at one end to a stationary object; and
wherein in each of said rows, each of said buoys is pivotally connected to the second end of said piston.

14. The energy conversion system of claim 1 or 2 further comprises an electric generator for converting said rotation of said hydraulic motor, into electric energy, and wherein said electric energy is operatively connected said water desalination unit.
